(19) United States
(12) Patent Application Publication
(10) Pub. No.: US 2012/0040035 A1
(43) Pub. Date: Feb. 16, 2012

(54) CAPTIVE SCREW FABRICATION MOLD

(76) Inventor: Ming-Chung CHIU, Keelung City (TW)

(21) Appl. No.: 12/853,899

(22) Filed: Aug. 10, 2010

(51) Int. Cl. B29C 45/14

(52) U.S. Cl. 425/110

(57) ABSTRACT

A captive screw fabrication mold for molding a plastic or rubber knob on the head of a lock screw for captive screw is disclosed to include a bottom die having a tubular post vertically disposed in each bottom die cavity thereof for holding a lock screw for molding, and an upper die that has an annular rib vertically downwardly suspending in each upper die cavity thereof for stopping against the head of the lock screw in the associating bottom die cavity around the top protrusion of the lock screw to isolate the molding chamber in each upper die cavity, avoiding overflow of the applied molten material into the tool groove in the top protrusion of each lock screw.

### BACKGROUND OF THE INVENTION

1. Field of the Invention

The present invention relates to captive screw fabrication technology and more particularly, to a captive screw fabrication mold, which prevents overflow of the applied molten material into the tool groove in the top protrusion at the top side of the head of each lock screw when molding a knob on the head of each lock screw for captive screw.

2. Description of the Related Art

When fastening panel frames together, a positioning screw formed of a cap-shaped knob, a ring and a screw nail is usually used. During installation, the screw nail and the ring are secured to the first panel frame, and then the cap-shaped knob is rotated to drive the screw nail into the second panel frame, and then a hand tool is used to fasten tight the screw nail, affixing the first and second panel frames together. This panel frame joining method can be used in a machine tool to join panel frames together. The power drive and speed-adjustment unit of a machine tool are generally provided inside the housing. When the power drive or speed-adjustment unit fails, or when an adjustment of the speed is necessary, the panel frames must be unlocked. When unlocked the panel frames, the positioning screws may be missed accidentally.

To facilitate detachable installation, captive screws are developed. Conventional captive screws are commonly formed of a cap member, a screw, a spring member and a mounting barrel, and adapted for locking into plate on a first panel frame, enabling the easy installation and removal of attached pieces without release of the screw. However, after insertion of the screw into the cap member during the assembly process, a secondary processing process is necessary to secure the metal cap member to the head of the screw, wasting much time and labor. Further, the cap member may be permanently deformed when fastening the cap member and the screw together.

To avoid this problem, plastic cap member may be used and directly molded on the head of the screw. The plastic cap member has damp-proof and anti-corrosion characteristics. Further, the plastic cap member can be made in any of a variety of colors. However, because the screw is made through a cold forging processing process, the head and threaded shank of the screw may be not kept in a perfect concentric relationship. Further, the screw head a tool groove on the top side of the head. The tool groove can be a keystone groove, crossed groove, hexagonal groove, or key groove for the positioning of a keystone tip screwdriver, Phillips tip screwdriver, hexagonal wrench, open-end wrench, socket wrench, or ratchet wrench. When molding the plastic cap on the head of the screw, the molten material may flow into the tool groove of the screw. If the tool groove is stuffed with the applied material, the finished captive screw will become a defective product, not operable by a hand tool (such as a screwdriver).

Therefore, it is desirable to provide a way that prevents overflow of the applied molten material during molding of a cap member on the head of a screw for captive screw, improving the yield and quality of the fabrication of captive screws.

### SUMMARY OF THE INVENTION

The present invention has been accomplished under the circumstances in view. It is therefore an object of the present invention to provide a captive screw fabrication mold, which prevents overflow of the applied molten material during molding of a cap member on the head of a screw for captive screw, improving the yield and quality of the fabrication of captive screws.

To achieve this and other objects of the present invention, a captive screw fabrication mold comprises a bottom die having a tubular post vertically disposed in each bottom die cavity thereof for holding a lock screw for molding, and an upper die that has an annular rib vertically downwardly suspending in each upper die cavity thereof for stopping against the head of the lock screw in the associating bottom die cavity around the top protrusion of the lock screw to isolate the molding chamber in each upper die cavity, avoiding overflow of the applied molten material into the tool groove in the top protrusion of each lock screw.

Further, an annular groove is defined on the top side of the head of the lock screw between the top protrusion of the lock screw and the molded cap-shaped knob at the head of the lock screw so that a user can insert a tool into the tool groove in the top protrusion of the lock screw accurately without touching the cap-shaped knob, facilitating operation of the attached tool.

Further, the vertical length of the annular rib has a certain height so that so that a gap is left inside the annular rib between the upper die and the top wall of the top protrusion of the lock screw when the upper die is closed on the bottom die to stop the annular rib against the top wall of the top protrusion of the lock screw, avoiding damaging the top protrusion.

Further, the annular rib in each upper die cavity can be formed integral with a sliding block in one respective stepped sliding slot, and a spring member is provided in the sliding slot and stopped against sliding block to impart a downward pressure to the sliding block against the head of the lock screw. Thus, the annular rib can be positively stopped against the top wall of the head of the lock screw around the top protrusion without causing any damage.

### BRIEF DESCRIPTION OF THE DRAWINGS

FIG. 1 is an exploded view of a captive screw fabrication mold in accordance with the present invention.

FIG. 2 is a sectional view, in an enlarged scale, of the captive screw fabrication mold shown in FIG. 1.

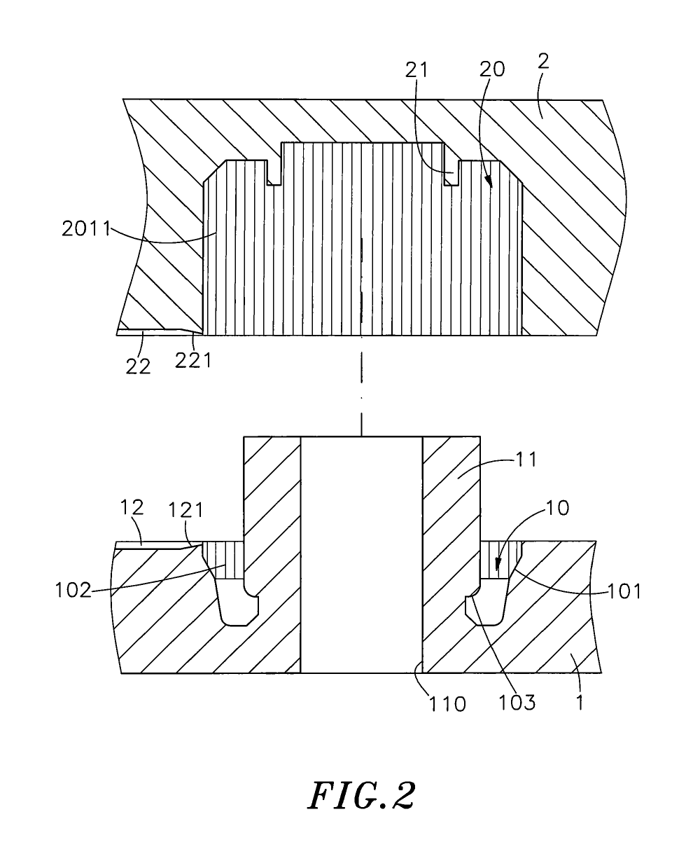

FIG. 3 is a schematic sectional side view of a part of the captive screw fabrication mold in accordance with the present invention, showing a lock screw inserted through the post in one bottom die cavity of the bottom die and the annular rib in the associating upper die cavity of the upper die pressed on the top wall of the head of the lock screw.

FIG. 4 corresponds to FIG. 3, showing a molten material filled in the upper die cavity of the upper die and the associating bottom die cavity of the bottom die.

FIG. 5 is an exploded view of a captive screw according to the present invention.

FIG. 6 is a sectional assembly view of the captive screw shown in FIG. 5.

FIG. 7 is an applied view of the captive screw according to the present invention.

FIG. 8 illustrates an alternate form of the captive screw fabrication mold in accordance with the present invention.

### DETAILED DESCRIPTION OF THE PREFERRED EMBODIMENT

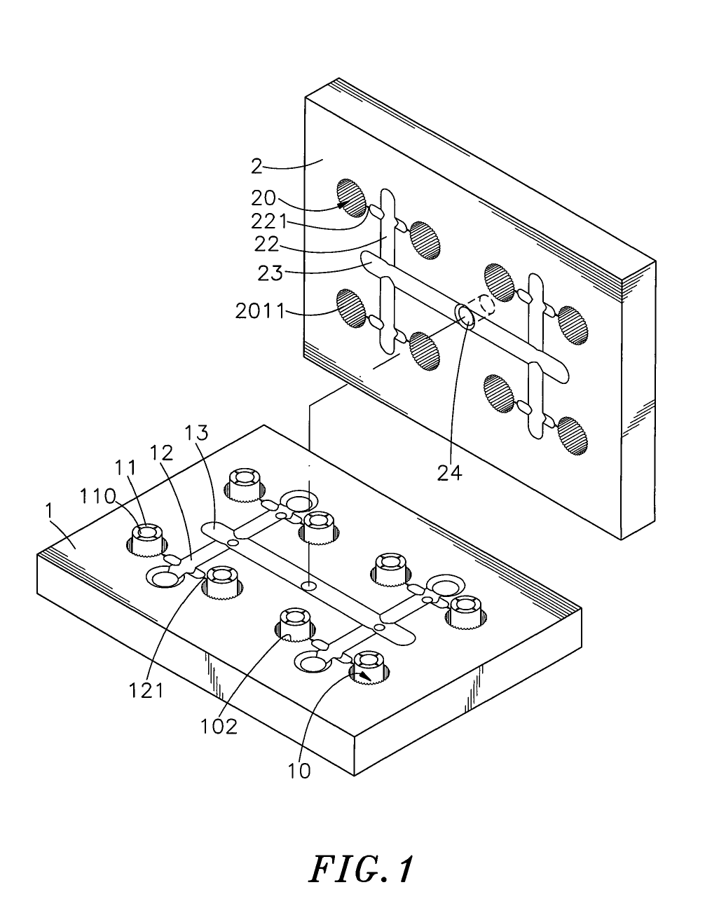

Referring to FIGS. 1˜3, a captive screw fabrication mold in accordance with the present invention comprises a bottom die 1 and an upper die 2.

The bottom die 1 comprises a plurality of bottom die cavities 10 inwardly curved from the top wall thereof and arranged at selected locations, a post 11 vertically disposed in each bottom die cavity 10 at the center, a vertical through hole 110 axially extending through the post 11 in each bottom die cavity 10 in communication with the space outside the bottom die 1, a step 101 located on the peripheral wall of each bottom die cavity 10, a series of teeth 102 located on the step 101 in each bottom die cavity 10, a curved surface portion 103 formed in each bottom die cavity 10 between the associating teeth 102 and the associating post 11 at the bottom side and extending around the associating post 11, a bottom main flow passage 13 located on the top wall thereof, a plurality of bottom sub flow passages 12 located on the top wall thereof and extending across the bottom main flow passage 13, and a plurality of bottom filling grooves 121 located on the top wall thereof and respectively connected between the bottom sub flow passages 12 and the bottom die cavities 10.

The upper die 2 comprises a plurality of upper die cavities 20 inwardly curved from the bottom wall thereof and arranged at locations corresponding to the bottom die cavities 10 of the bottom die 1, an annular rib 21 vertically downwardly suspending in each upper die cavity 20 and defining with the peripheral wall of the associating upper die cavity 20 a molding chamber 201, a series of teeth 2011 disposed in the molding chamber 201 in each upper die cavity 20, a upper main flow passage 23 located on the bottom wall thereof, a plurality of upper sub flow passages 22 located on the bottom wall thereof and extending across the upper main flow passage 23, a plurality of upper filling grooves 221 located on the bottom wall thereof and respectively connected between the upper sub flow passages 22 and the upper die cavities 20, and a filling hole 24 cut through top and bottom walls thereof in communication with the upper main flow passage 23 for the filling of a molten material.

The captive screw fabrication mold is adapted for molding a cap-shaped knob 34 on each of a number of lock screws 3. The lock screw 3 has a threaded shank 31, a head 32 located on one end of the threaded shank 31, a top protrusion 33 raised from the top wall of the head 32 opposite to the threaded shank 31 and a tool groove 331 formed in the top protrusion 33 and capable of being engaged by a driving tool or implement, such as a screwdriver (not shown). After insertion of one lock screw 3 in the vertical through hole 110 in the post 11 in each bottom die cavity 10 of the bottom die 1 and closing of the upper die 2 on the bottom die 1, a molten material is filled through the filling hole 24 into the upper die cavities 20 and the bottom die cavities 10, molding a cap-shaped knob 34 on the head 32 of each lock screw 3.

During application, the threaded shank 31 of each lock screw 3 is inserted into the vertical through hole 110 in the post 11 in one bottom die cavity 10 of the bottom die 1 to let the head 32 of the each lock screw 3 be rested on the topmost edge of the respective post 11. Thereafter, the upper die 2 is closed on the bottom die 1 to press the annular rib 21 in each upper die cavity 20 on the top wall of the head 32 of each lock screw 3 around the top protrusion 33, thereby isolating the respective molding chamber 201. At this time, the upper filling grooves 221, upper sub flow passages 22, upper main flow passage 23 and filling hole 24 of the upper die 2 are kept in communication with the bottom filling grooves 121, bottom sub flow passages 12 and bottom main flow passage 13 of the bottom die cavities 10.

Further, the teeth 2011 in the molding chamber 201 in each upper die cavity 20 of the upper die 2 and the teeth 102 on the step 101 in each bottom die cavity 10 of the bottom die 1 can be made having a V-shaped, U-shaped, arched, semi-circular, wave-like or trapezoidal cross section.

Further, the post 11 in each bottom die cavity 10 of the bottom die 1 can be a cylindrical post, rectangular post or polygonal post.

Further, the top protrusion 33 of the lock screw 3 is a flat, circular protrusion concentrically located on the top wall of the head 32. Further, the tool groove 331 of the lock screw 3 can be a keystone groove, crossed groove, hexagonal groove, or key groove for the positioning of a keystone tip screwdriver, Phillips tip screwdriver, hexagonal wrench, open-end wrench, socket wrench, or ratchet wrench. The excellent concentricity between the head 32 and top protrusion 33 of the lock screw 3 enables the top protrusion 33 of the lock screw 3 to be accurately inserted into the annular rib 21 in the respective upper die cavity 20 of the upper die 2 upon closing of the upper die 2 on the bottom die 1. Thus, when molding a cap-shaped knob 34 on the head 32, the applied molten material is kept in the molding chamber 201 in each upper die cavity 20 and prohibited by the annular rib 21 in each upper die cavity 20 from flowing to the top protrusion 33 of each loaded lock screw 3.

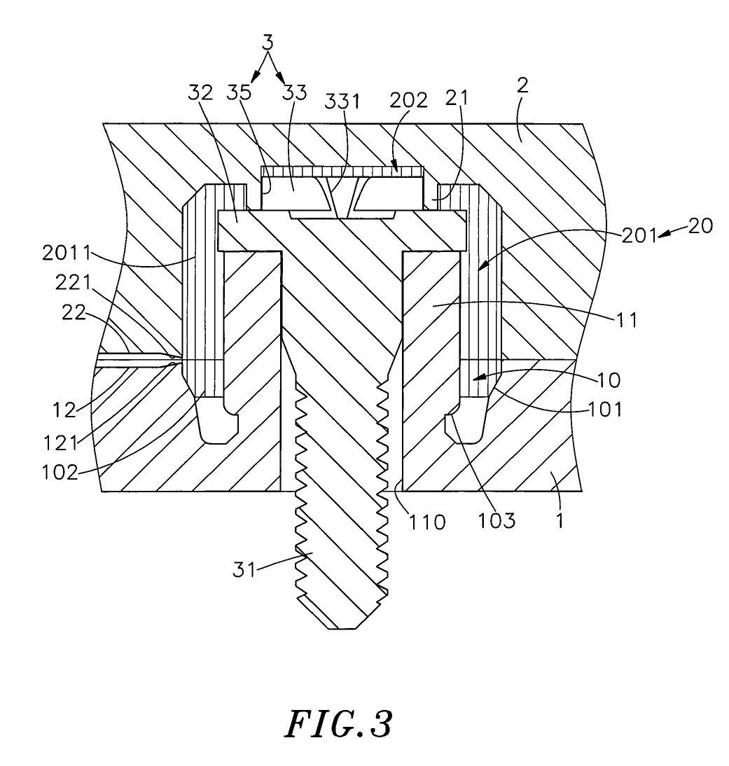

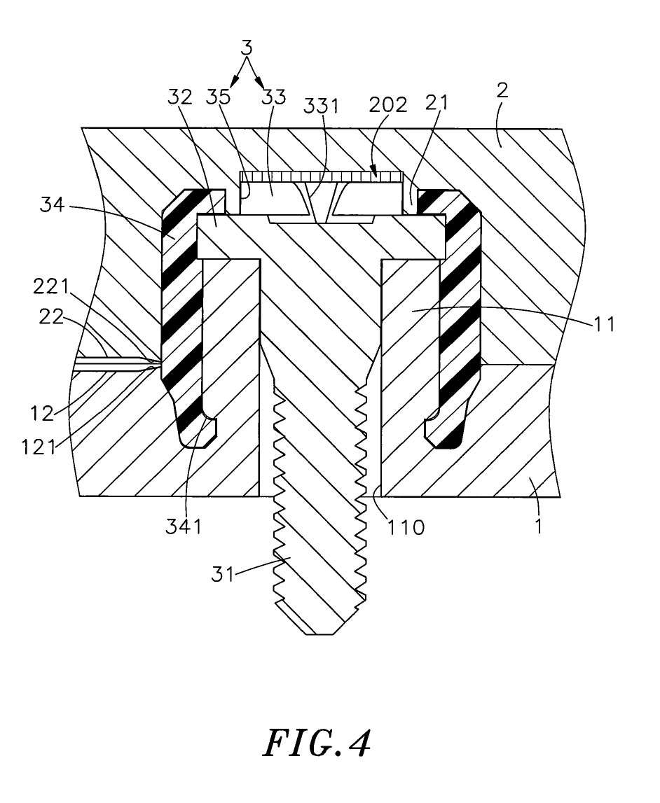

Referring to FIGS. 4˜6 and FIG. 1 and FIG. 3 again, during application of the present invention, a molten material (molten plastic or rubber) is filled through the filling hole 24 into the upper die cavities 20 and the bottom die cavities 10 through the upper main flow passage 23 and bottom main flow passage 13 and the upper sub flow passages 22 and bottom sub flow passages 12 via the bottom filling grooves 121 and upper filling grooves 221 to fill up the molding chamber 201 in each upper die cavity 20 of the upper die 2 and each bottom die cavity 10 of each bottom die 1, thereby forming a cap-shaped knob 34 on the head 32 of each loaded lock screw 3. Subject to the design of the teeth 2011 in the molding chamber 201 in each upper die cavity 20 of the upper die 2 and the teeth 102 on the step 101 in each bottom die cavity 10 of the bottom die 1 and the design of the curved surface portion 103 in each bottom die cavity 10 of the bottom die 1, the cap-shaped knob 34 that is molded on the head 32 of each lock screw 3 has a toothed design on the periphery and a bottom coupling flange 341 inwardly curved from the bottom side thereof. Each lock screw 3 that has a cap-shaped knob 34 molded thereon can then be assembled with one barrel 37 and one spring member 36 to form a captive screw 4.

When molding a cap-shaped knob 34 on the head 32 of each lock screw 3 in the captive screw fabrication mold, the annular rib 21 in each upper die cavity 20 of the upper die 2 is pressed on the top wall of the head 32 of the respective lock screw 3 around the top protrusion 33 to isolate the respective molding chamber 201, avoiding flowing of the applied molten material to the tool groove 331 in the top protrusion 33 of each loaded lock screw 3. The excellent concentricity between the head 32 and top protrusion 33 of the lock screw 3 enables the top protrusion 33 of the lock screw 3 to be accurately inserted into the annular rib 21 in the respective upper die cavity 20 of the upper die 2 upon closing of the upper die 2 on the bottom die 1. Therefore, the top protrusion 33 of the lock screw 3 will not be damaged by the corresponding annular rib 21 when closing the upper die 2 on the bottom die 1, and the tool groove 331 in the top protrusion 33 of each loaded lock screw 3 is kept clean. After molding of a cap-shaped knob 34 on the head 32 of each lock screw 3, an annular groove 35 is defined on the top side of the head 32 of each lock screw 3 between the top protrusion 33 and the cap-shaped knob 34. Thus, a user can insert a tool into the tool groove 331 in the top protrusion 33 of the lock screw 3 accurately without touching the cap-shaped knob 34, facilitating operation of the attached tool. Thus, the invention greatly improves the yield and quality of the fabrication of captive screws 4.

Further, the annular rib 21 in the respective upper die cavity 20 of the upper die 2 can be made having raised portions (not shown) located on the outer wall thereof so that the molded cap-shaped knob 34 can have decorative recessed portions on the outer wall thereof. The raised portions of the annular rib 21 can have a circular, oval, arched, geometric, polygonal profile or irregular profile.

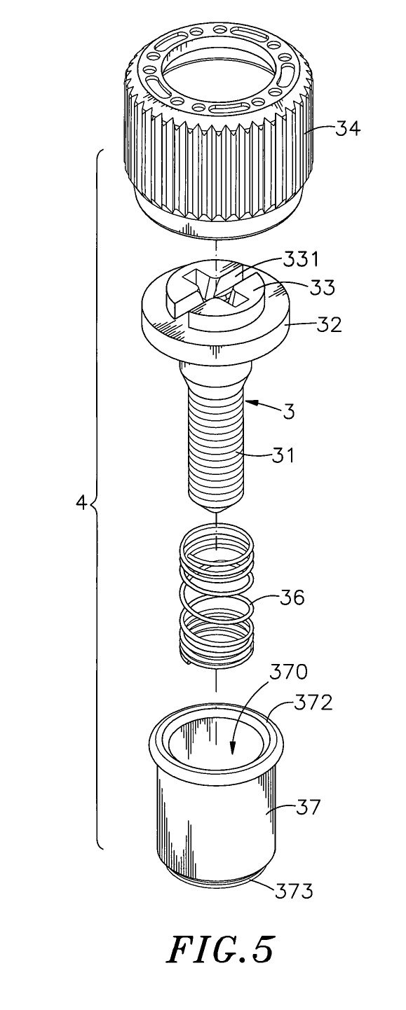

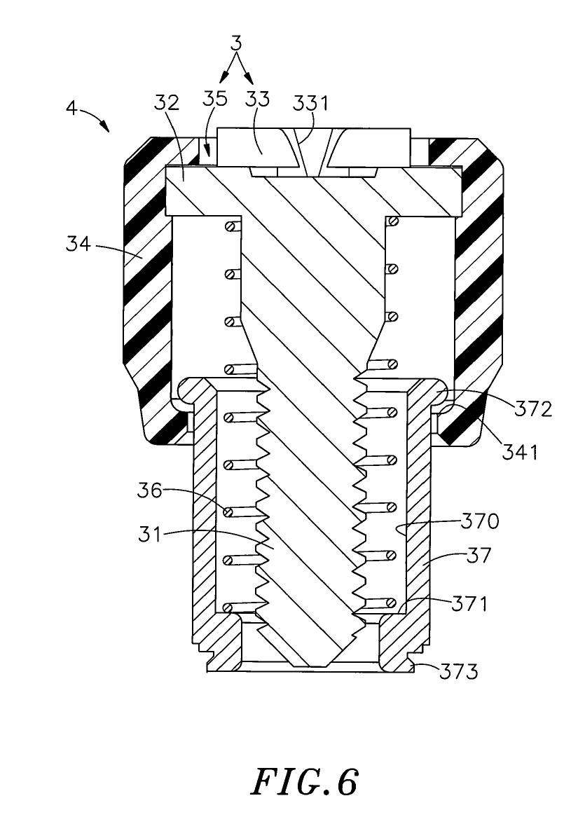

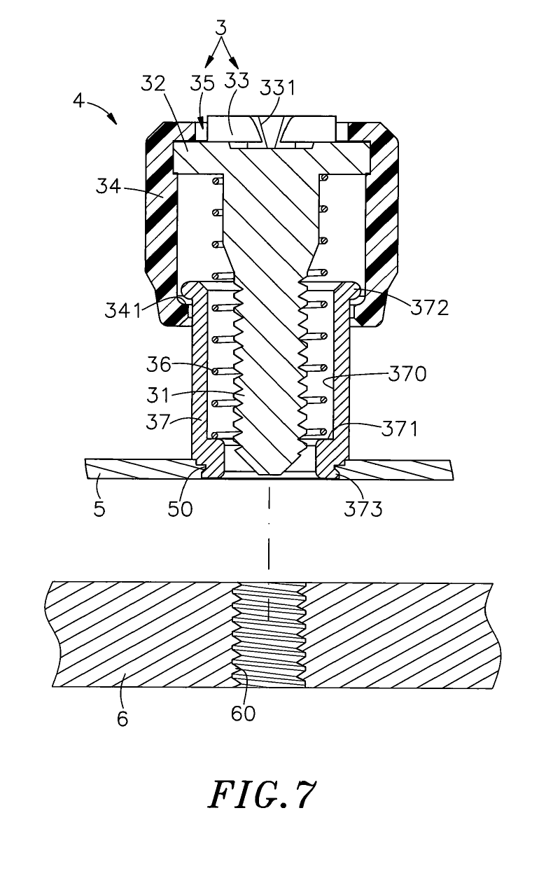

Referring to FIG. 7 and FIGS. 5 and 6 again, after molding of the cap-shaped knob 34 on the head 32 of one lock screw 3, the lock screw 3 is assembled with one barrel 37 and one spring member 36 to form a captive screw 4. The barrel 37 comprises a top coupling flange 372 extending around the periphery of the top end thereof, a contracted bottom mounting portion 373 axially extended from the bottom end thereof, a stepped axial hole 370 extending through the top and bottom ends and a step 371 defined in the stepped axial hole 370. During the assembly process, the spring member 36 is sleeved onto the threaded shank 31 of the lock screw 3 and stopped between the step 371 in the stepped axial hole 370 of the barrel 37 and the bottom wall of the head 32 of the lock screw 3, and the bottom coupling flange 341 of the cap-shaped knob 34 is coupled to the top coupling flange 372 of the barrel 37. When assembled, the cap-shaped knob 34 can be moved with the lock screw 3 axially relative to the barrel 37.

During application of the captive screw 4, the contracted bottom mounting portion 373 of the barrel 37 is fixedly bonded to a mounting through hole 50 on a first metal panel 5. At this time, the user can thread the threaded shank 31 of the lock screw 3 into a mounting screw hole 60 on a second metal panel 6 to lock the first metal panel 5 to the second metal panel 6.

Referring to FIGS. 3 and 4 again, the vertical length of the annular rib 21 can be greater than the height of the top protrusion 33 of the lock screw 3 so that a gap 202 is left inside the annular rib 21 between the upper die 2 and the top wall of the top protrusion 33 of the lock screw 3 when the upper die 2 is closed on the bottom die 1 to stop annular rib 21 against the head 32 of the lock screw 3, avoiding damage.

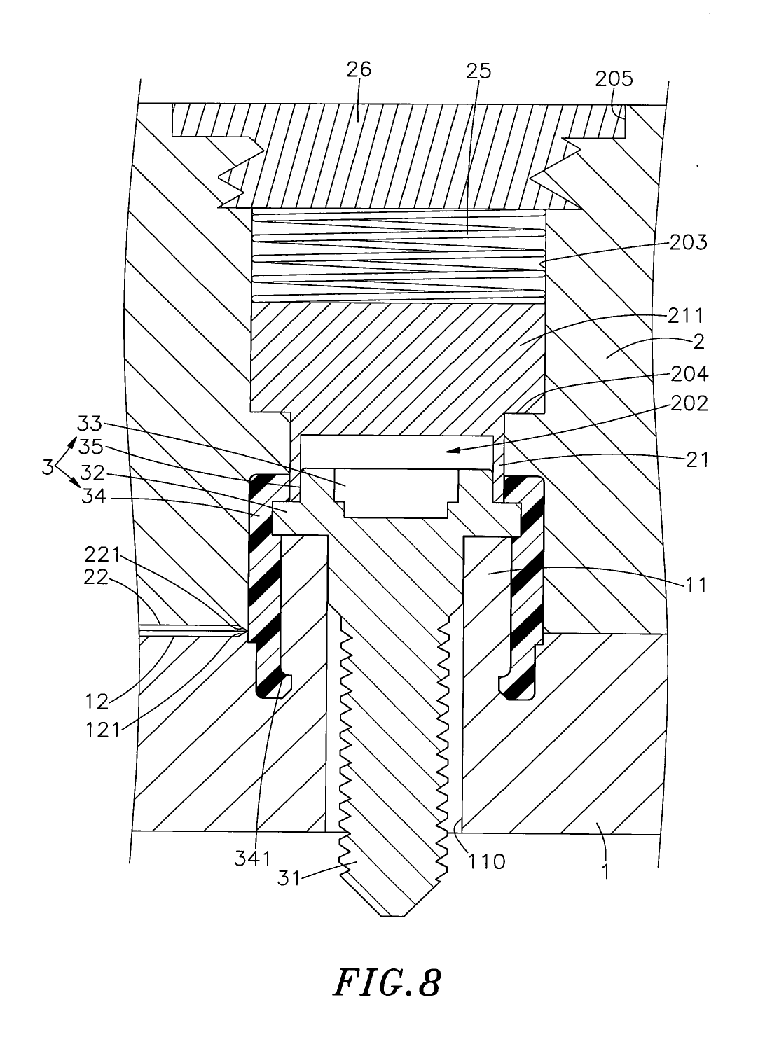

Referring to FIG. 8 and FIG. 1 again, as an alternate form of the present invention, the upper die 2 further comprises a plurality of locating holes, for example, threaded holes 205 located on the top wall thereof corresponding to the upper die cavities 20, a plurality of stepped sliding slots 203 respectively axially connected between the threaded holes 205 and the upper die cavities 20, a step 204 defined in each stepped sliding slots 203, a sliding block 211 inserted into each stepped sliding slot 203 and stoppable by the step 204 in the associating stepped sliding slot 203, a cap 26 threaded into each threaded hole 205 and a spring member 25 inserted in each stepped sliding slot 203 and stopped between the associating cap 26 and the associating sliding block 211 to impart a downward pressure to the associating sliding block 211 against the head 32 of the lock screw 3 in the associating upper die cavity 20. The annular rib 21 in each upper die cavity 20 according to this embodiment is formed integral with the bottom wall of the sliding block 211 in the associating stepped sliding slot 203. However, the annular rib 21 of each sliding block 211 has a height relatively greater than the embodiment shown in FIGS. 3 and 4. When the upper die 2 is closed on the bottom die 1 to stop the annular rib 21 of each sliding block 211 against the head 32 of the lock screw 3 in the associating upper die cavity 20, the spring member 25 is compressed, and a relatively greater gap 202 is left in the annular rib 21 between the top protrusion 33 of the lock screw 3 and the bottom wall of the associating sliding block 211, avoiding damage. When the upper die 2 is opened from the bottom die 1 after a molding operation, the external pressure is released from the spring member 25, and therefore the spring member 25 returns to its former shape to return the associating sliding block 211 to its former position, i.e., to stop the associating sliding block 211 against the step 204 in the associating stepped sliding slot 203.

The aforesaid two embodiments are simply exemplars of the present invention and not to be used as limitations. During the use of the captive screw fabrication mold, captive screws 3 are loaded in the bottom die cavities 10 of the bottom die 1, and then the upper die 2 is closed on the bottom die 1 to force the annular rib 21 in each upper die cavity 20 against the head 32 of the respective lock screw 3 around the top protrusion 33 of the respective lock screw 3, isolating the associating molding chamber 201 and avoiding flowing of the applied molten material to the tool groove 331 in the top protrusion 33 of each loaded lock screw 3. Further, an annular groove 35 is defined on the top side of the head 32 of each lock screw 3 between the top protrusion 33 and the molded cap-shaped knob 34 so that a user can insert a tool into the tool groove 331 in the top protrusion 33 of the lock screw 3 accurately without touching the cap-shaped knob 34, facilitating operation of the attached tool.

In actual practice, the captive screw fabrication mold of the present invention has the following advantages and features:
1. An annular rib 21 is disposed in each upper die cavity 20 for stopping against the head 32 of the respective loaded lock screw 3 to isolate the associating molding chamber 201, avoiding flowing of the applied molten material to the tool groove 331 in the top protrusion 33 of each loaded lock screw 3. After molding of the cap-shaped knob 34 on each lock screw 3, the tool groove 331 of each lock screw 3 is kept clean, facilitating operation of a tool means during installation of the finished captive screw.
2. An annular groove 35 is defined on the top side of the head 32 of each lock screw 3 between the top protrusion 33 and the molded cap-shaped knob 34 so that a user can insert a tool into the tool groove 331 in the top protrusion 33 of the lock screw 3 accurately without touching the cap-shaped knob 34, facilitating operation of the attached tool.
3. The vertical length of the annular rib 21 can be greater than the height of the top protrusion 33 of the lock screw 3 so that a gap 202 is left inside the annular rib 21 between the upper die 2 and the top wall of the top protrusion 33 of the lock screw 3 when the upper die 2 is closed on the bottom die 1 to stop the annular rib 21 against the top wall of the top protrusion 33 of the lock screw 3, avoiding damaging the top protrusion 33.
4. In an alternate form of the present invention, the upper die 2 is made having a locating hole (threaded hole) 205 located on the top wall thereof corresponding to each upper die cavity 20, a stepped sliding slot 203 in communication between each locating hole (threaded hole) 205 and the associating upper die cavity 20, a step 204 defined in each stepped sliding slot 203, a sliding block 211 inserted into each stepped sliding slot 203 and stoppable by the step 204 in the associating stepped sliding slot 203, a cap 26 threaded into each locating hole (threaded hole) 205 and a spring member 25 inserted in each stepped sliding slot 203 and stopped between the associating cap 26 and the associating sliding block 211 to impart a downward pressure to the associating sliding block 211 against the head 32 of the lock screw 3 in the associating upper die cavity 20; the annular rib 21 in each upper die cavity 20 is formed integral with the bottom wall of a sliding block 211 that is inserted into each stepped sliding slots 203 and stoppable by the step 204 in the associating stepped sliding slot 203, a cap 26 threaded into each threaded hole 205 and a spring member 25 inserted in each stepped sliding slot 203 and stopped between the associating cap 26 and the associating sliding block 211 to impart a downward pressure to the associating sliding block 211 against the head 32 of the lock screw 3 in the associating upper die cavity 20, and the annular rib 21 in each upper die cavity 20 is formed integral with the bottom wall of the sliding block 211 in the respective upper die cavity 20. Thus, the annular rib 21 can be positively stopped against the top wall of the head 32 of the lock screw 3 without causing any damage.

Although particular embodiment of the invention have been described in detail for purposes of illustration, it will be obvious that various modifications and enhancements may be made therein without departing from the spirit and scope of the present invention as defined in the disclosure and the claims.

What the invention claimed is:

1. A captive screw fabrication mold adapted for molding an applied molten material to form a knob on a head of a lock screw for captive screw around a top protrusion of the lock screw, comprising:
a bottom die, said bottom die comprising at least one inwardly curved from a top wall thereof and arranged at selected locations, a post vertically disposed in each said bottom die cavity and a vertical through hole axially extending through the post in each said bottom die cavity in communication with the space outside said bottom die; and
an upper die for closing on the top wall of said bottom die, said upper die comprising at least one upper die cavity inwardly curved from a bottom wall thereof corresponding to said at least one bottom die cavity of said bottom die and an annular rib vertically downwardly suspending in each said upper die cavity for stopping against the head of a lock screw being loaded in the post of the corresponding bottom die cavity around the top protrusion of the lock screw and defining with the peripheral wall of the associating upper die cavity a molding chamber for molding an applied molten material to form a knob on the head of the lock screw being loaded in the post of the corresponding bottom die cavity around the top protrusion of the lock screw.

2. The captive screw fabrication mold as claimed in claim 1, wherein said bottom die further comprises a bottom main flow passage located on the top wall thereof, a plurality of bottom sub flow passages located on the top wall thereof and extending across said bottom main flow passage, and a plurality of bottom filling grooves located on the top wall thereof and respectively connected between said bottom sub flow passages and multiple bottom die cavities of said at least one bottom die cavity; said upper die further comprises an upper main flow passage located on the bottom wall thereof corresponding to said bottom main flow passage, a plurality of upper sub flow passages located on the bottom wall thereof and extending across said upper main flow passage corresponding to said bottom sub flow passages, a plurality of upper filling grooves located on the bottom wall thereof and respectively connected between said upper sub flow passages and said upper die cavities corresponding to said bottom filling grooves, and a filling hole for the filling of a molten material from an external molten material supply source into said upper main flow passage.

3. The captive screw fabrication mold as claimed in claim 1, wherein the annular rib in each said upper die cavity has a cross section shaped like a circular, oval, arched, geometric, polygonal profile or irregular loop.

4. The captive screw fabrication mold as claimed in claim 1, wherein said upper die further comprises a series of teeth disposed in the molding chamber in each said upper die cavity, said teeth having a V-shaped, U-shaped, arched, semi-circular, wave-like or trapezoidal cross section.

5. The captive screw fabrication mold as claimed in claim 1, wherein the post in each said bottom die cavity has a circular, rectangular or polygonal cross section.

6. The captive screw fabrication mold as claimed in claim 1, wherein the annular rib in each said upper die cavity is formed integral with a part of said upper die.

7. The captive screw fabrication mold as claimed in claim 1, wherein said upper die further comprises at least one sliding slot respectively disposed in communication with said at least one upper die cavity and the space outside the top wall of said upper die, a sliding block slidably mounted in each said sliding slot, said sliding block having opposing top wall and bottom wall, and a spring member mounted in each said sliding slot and stopped against the top wall of the sliding block in the associating sliding slot to impart a downward pressure to the associating sliding block; the annular rib in each said upper die cavity is formed integral with the bottom wall of the associating sliding block and movable with the associating sliding block up and down in the associating upper die cavity.

8. The captive screw fabrication mold as claimed in claim 7, wherein said upper die further comprises a step defined in each said sliding slot for stopping each said sliding block in the associating sliding slot, a locating hole located on the top wall thereof corresponding to each said sliding slot and a cap fastened to said locating hole for stopping the spring member in the associating sliding slot against the associating sliding block.

9. The captive screw fabrication mold as claimed in claim 1, wherein said bottom die further comprises a step defined in the peripheral wall of each said bottom die cavity, a series of teeth located on the step in each said bottom die cavity, a curved surface portion formed in each said bottom die cavity between the associating teeth and the associating post at a bottom side.
